(19) United States
(12) Patent Application Publication
(10) Pub. No.: US 2007/0088592 A1
(43) Pub. Date: Apr. 19, 2007

(54) Methods and systems for scheduling events

(75) Inventors: Chien-Tsun Liu, Yunlin County (TW); Tse-Ming Tsai, Taipei County (TW); Chin-Cheng Wu, Taoyuan County (TW); Jun-Jie Liao, Taipei County (TW); Chun-Ho Chang, Taipei City (TW)

Correspondence Address: BIRCH STEWART KOLASCH & BIRCH, PO BOX 747, FALLS CHURCH, VA, 22040-0747, US

(73) Assignee: Institute for Information Industry

(21) Appl. No.: 11/336,893

(22) Filed: Jan. 23, 2006

(30) Foreign Application Priority Data
Oct. 18, 2005 (TW) 94136325

(51) Int. Cl. G06F 9/46

(52) U.S. Cl. 705/8

(57) ABSTRACT

A method for scheduling events according to network information. Network information, event information, and user preference information are acquired. The Network information is time-related. The network information, event information, and user preference information are then matched to obtain a matching result. Events are scheduled according to the matching result. Each event includes event name, event time, and event location. The scheduled events can be recorded in a personal

### BACKGROUND

The invention relates to event scheduling, and in particular to methods and systems for scheduling events based on network information.

With technical progress, a great quantity of information can be acquired through networks, such as the Internet. The acquired information may be time-related to various events. For example, websites of TV channels or theaters may provide program tables comprising schedule information. Events are generally arranged in a personal schedule established in a website or a digital electronic device. Due to retrieved network information being real-time and abundant, events can be arranged by referring to retrieved network information.

Conventionally, personal schedules are maintained in websites or digital electronic device, such as a personal digital assistant (PDA), a personal computer (PC), a mobile electronic communication device, or a handheld set, by owners.

The owners can obtain required information from networks by searching or by periodical electronic news. The acquired information is used for arranging events. After the events are scheduled, related messages can be sent to notify all persons involved.

Conventional methods reveal some drawbacks. For example, information search in networks is time-consuming and manual arrangements for events may cause errors. Furthermore, notification must be executed manually, causing inconvenience.

Thus, improved scheduling methods and systems to search network information and match with preference information for event scheduling are desirable.

### SUMMARY

Methods for scheduling events according to network information are provided. Search engines, such as crawlers, are used to retrieve information from a network, such as the Internet. Network information, event information, and user preference information are acquired. Here, the network information is time-related. The network information, event information, and user preference information is matched to obtain a matching result. Events are scheduled according to the matching result. Particularly, each event includes event name, event time, and event location.

### BRIEF DESCRIPTION OF THE DRAWINGS

Embodiments of the invention can be more fully understood by reading the subsequent detailed description and examples with references made to the accompanying drawings, wherein:

FIG. 1 is a flowchart of an embodiment of a method for scheduling events according to network information.

FIG. 2 is a diagram of an embodiment of a machine-readable storage medium storing a computer program providing a method for scheduling events according to network information.

FIG. 3 is a diagram of an embodiment of a system for scheduling events according to network information.

FIG. 4 is a diagram of another embodiment of a method for scheduling events according to network information.

FIG. 5 is a flowchart of all exemplary implementation of a tree structure.

### DETAILED DESCRIPTION

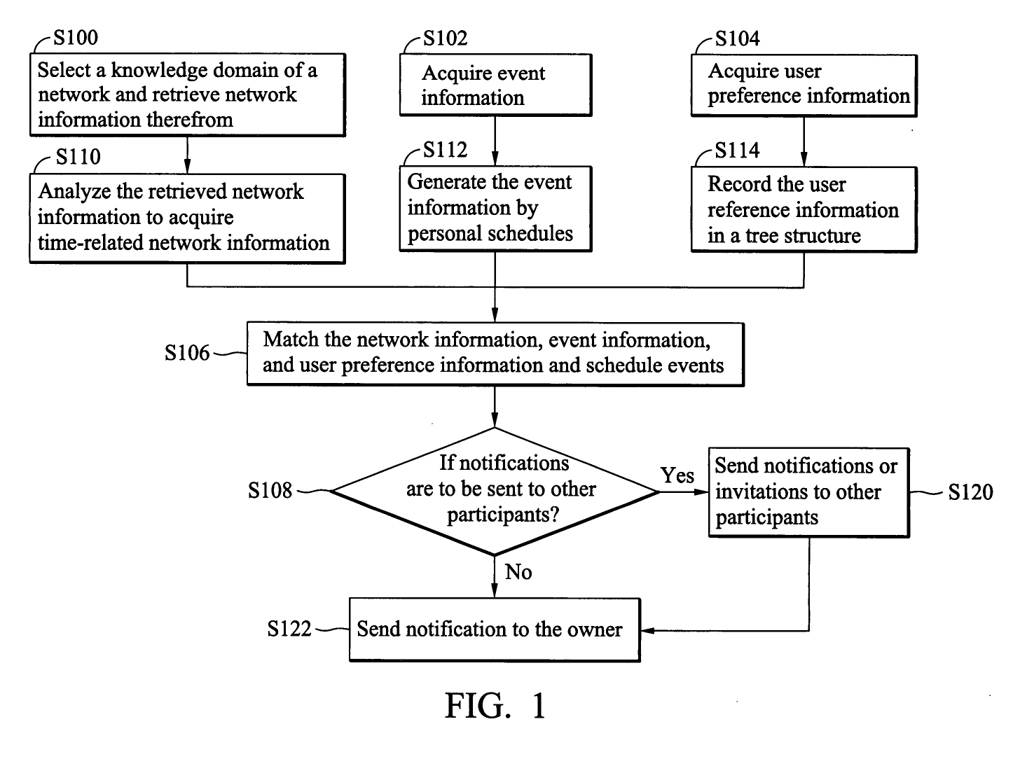

FIG. 1 is a flowchart of an embodiment of a method for scheduling events according to network information. A knowledge domain of a network is selected and network information is retrieved therefrom (step S100). For example, if sports and art are preferred knowledge domains, Internet websites related to sports and art are searched to retrieve network information. The network information of a preferred knowledge domain can be, for example, schedules of TV or movie channel, art performances, exhibition information, promotion information, or announces of governments. The time-related network information is retrieved by a network information search engine. The retrieved network information is then analyzed to acquire time-related network information (step S110). The time-related network information may comprise explicit and implicit time information. For example, network information, including exact date or time, belongs to explicit time information. Network information, including season, holiday, certain public affairs, or predicted date, belongs to implicit time information. Through information analysis, the explicit and implicit time information can be identified.

Furthermore, event information is acquired (step S102). The event information can be generated by personal schedules (step S112). For example, if a computer system includes a personal schedule recording event related information, the recorded information can be generated as event information.

Additionally, user preference information is acquired (step S104). The user reference information can be acquired by user input through a user interface or by analyzing user preference history records. The user reference information can be recorded in a tree structure (step S114).

The network information, event information, and user preference information are matched to obtain a matching result. Events are scheduled according to the matching result (step S106). Here, each event includes event name, event time; and event location. The scheduled events can be recorded in a personal schedule.

Afterwards, it is determined if notifications are to be sent to other participants according to the scheduled events (step S108). For example, if an event requires other participants, notifications or invitations can be sent thereto (step S120). An event may only require one person involved (step S122), e.g. the owner of the personal schedule. The notification can be sent by common communication methods, such as short messages. The notifications can be implemented as alarms to avoid missing of important event.

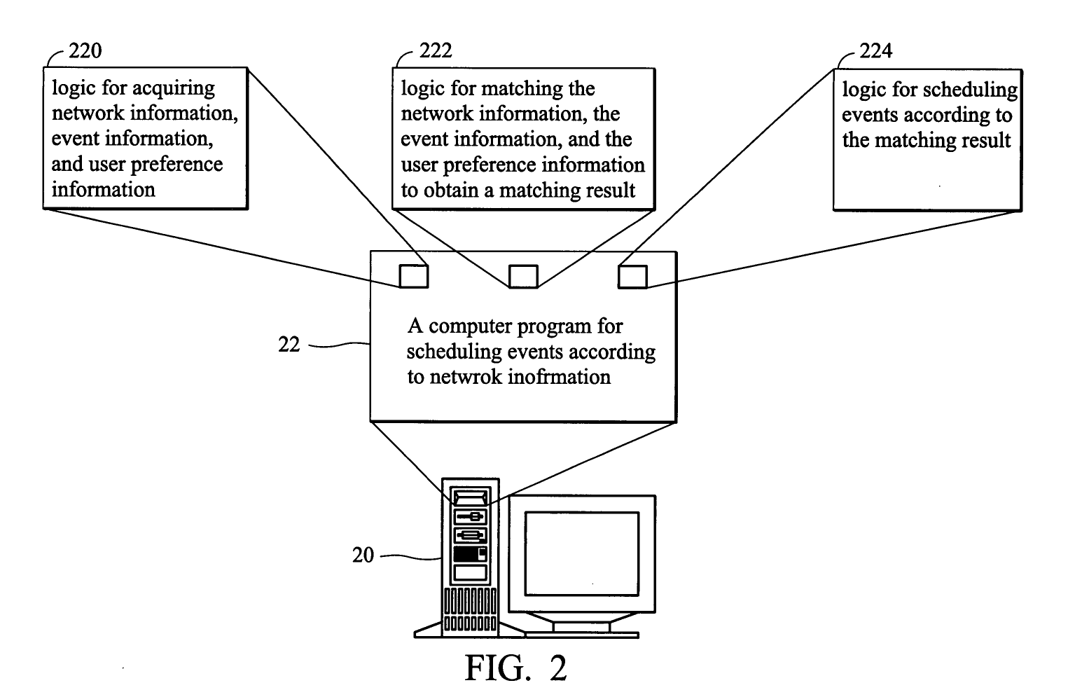

The method can be implemented in computer programs. FIG. 2 is a diagram of an embodiment of a machine-readable storage medium storing a computer program providing a method for scheduling events according to network information. As shown in FIG. 2, machine-readable storage medium 20 stores a computer program 22. The computer program 22 mainly comprises logic acquiring network information, event information, and user preference information 220, logic matching the network information, the event information, and the user preference information to obtain a matching result 222, and logic scheduling events according to the matching result 224.

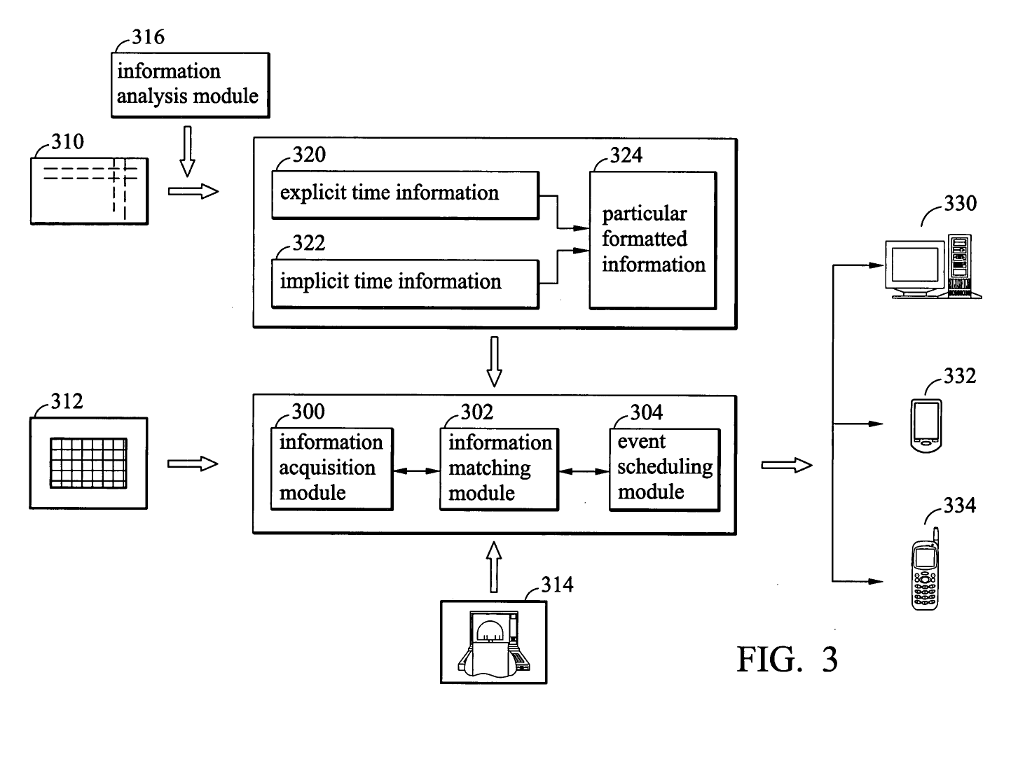

FIG. 3 is a diagram of an embodiment of a system for scheduling events according to network information, comprising an information acquisition module 300, information matching module 302, and event scheduling module 304. The information acquisition module 300 acquires time-related network information 310, event information 312, and user preference information 314.

The information matching module 302 matches the network information 310, event information 312, and user preference information 314 to obtain a matching result. The event scheduling module 304 schedules events according to the matching result. Each event includes event name, event time, and event location. The scheduled events can be recorded in a personal schedule.

The time-related network information 310 comprises explicit time information 320 and implicit time information 322. The time-related network information 310 can be retrieved by a network information search engine from a knowledge domain of a network. The time-related network information can be processed to particular formats 324 for further identification and matching. An information analysis module 316 can be further provided to analyze information of the knowledge domain to require the time-related network information 310.

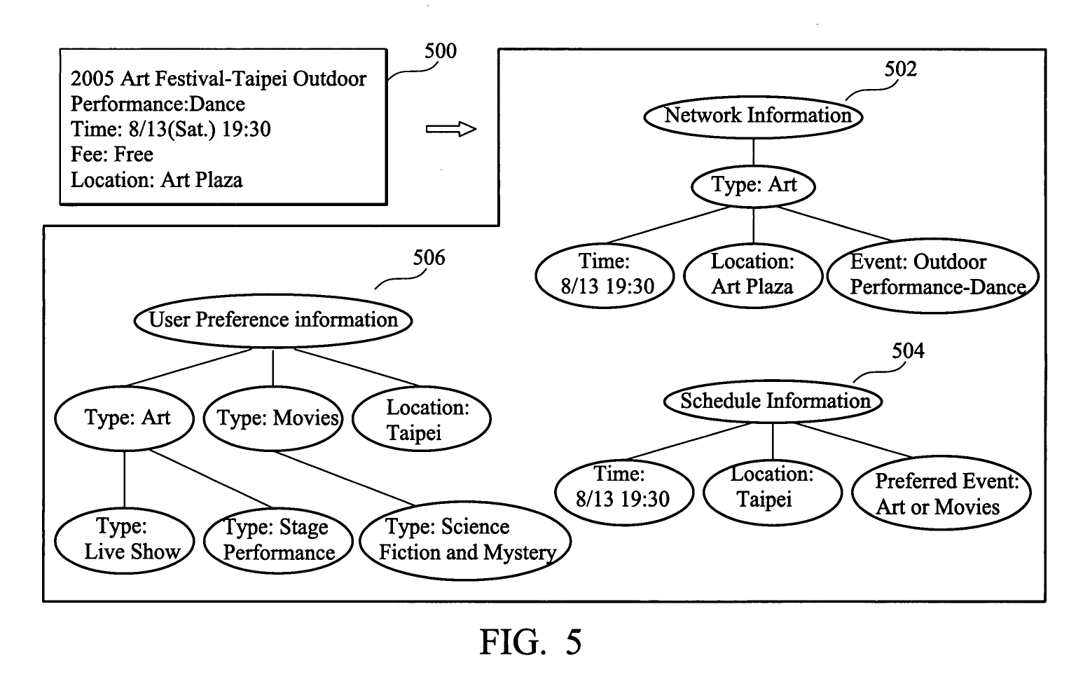

A notification module 304 is further provided sending notifications according to the scheduled events. The notifications can be sent to different destinations, such as computer systems 330, PDAs 332, or handheld sets 334. The user reference information can be acquired by a user interface and recorded in a tree structure. FIG. 5 is a flowchart of an exemplary implementation of a tree structure. Time-related network information 500 as shown in the left side of FIG. 5 can be analyzed and processed to a tree structure 502 as shown in the right side of FIG. 5. The tree-structured network information can be matched with the schedule information 504 and user preference information 506 to obtain the matching result.

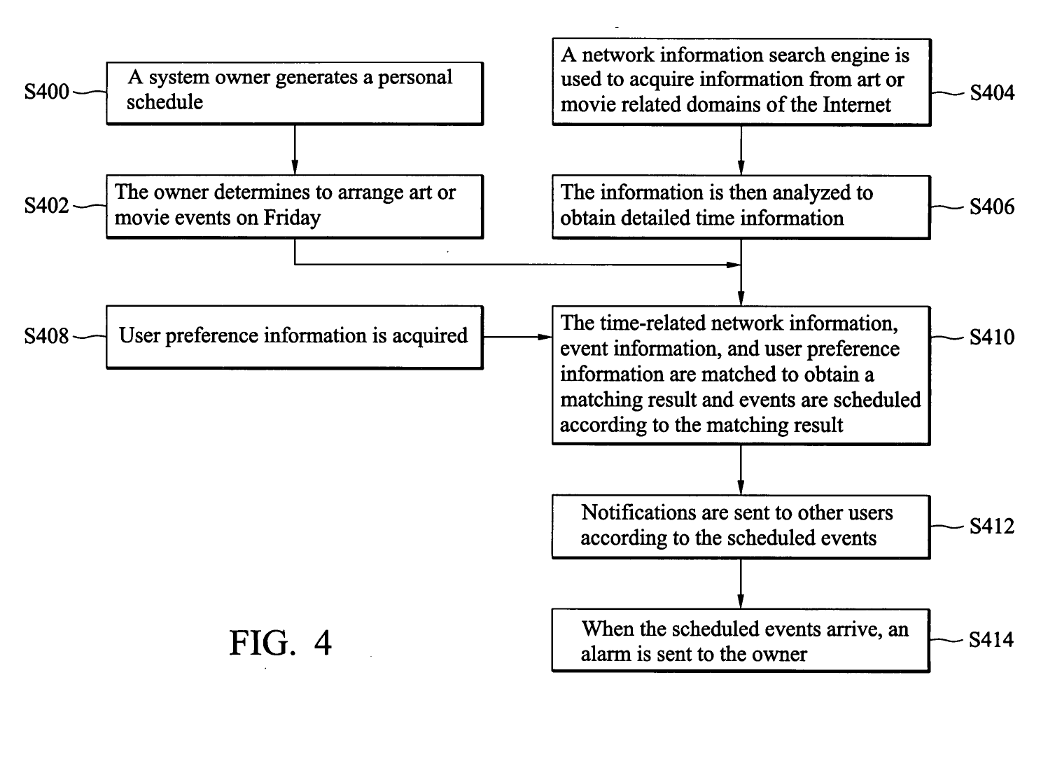

FIG. 4 is a diagram of another embodiment of a method for scheduling events according to network information. A system owner generates a personal schedule (step S400). For example, the owner determines to arrange art or movie events on Friday (step S402). A network information search engine, such as a crawler, is used to acquire information from art or movie related domains of the Internet (step S404). The information is then analyzed to obtain detailed time information, such as event time, event location, or event content (step S406).

User preference information is acquired (step S408). The user preference information can be recorded in a tree structure. The time-related network information, event information, and user preference information are matched to obtain a matching result (step S410). Events are scheduled according to the matching result. Each event may include event name, event time, and event location.

The scheduled events can be recorded in a personal schedule. Notifications can be sent to other users according to the scheduled events (step S412). When the scheduled events arrive, an alarm can be sent to the owner (step S414).

Embodiments of the present invention provide scheduling methods for events according to network information. The provided methods improve passive network information reception and manual event scheduling. The provided methods also can notify or alarm users properly, reducing scheduling errors.

Methods of the present invention, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing and embodiment of the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

1. A method for scheduling events according to network information, comprising:
acquiring network information, event information, and user preference information, wherein the network information is time-related;
matching the network information, the event information, and the user preference information to obtain a matching result; and
scheduling at least one event according to the matching result, wherein each event comprises event name, event time, and event location.

2. The method for scheduling events according to network information as claimed in claim 1, wherein the time-related network information comprises explicit time information and implicit time information.

3. The method for scheduling events according to network information as claimed in claim 1, wherein the time-related network information is retrieved based on a knowledge domain of a network.

4. The method for scheduling events according to network information as claimed in claim 3, wherein the time-related network information is retrieved by a network information search engine.

5. The method for scheduling events according to network information as claimed in claim 3, further analyzing information of the knowledge domain to acquire the time-related network information.

6. The method for scheduling events according to network information as claimed in claim 1, wherein the user reference information is recorded in a tree structure.

7. The method for scheduling events according to network information as claimed in claim 1, wherein the user reference information is acquired by a user interface.

8. The method for scheduling events according to network information as claimed in claim 1, wherein the scheduled events are recorded in a personal schedule.

9. The method for scheduling events according to network information as claimed in claim 1, further sending a notification according to the scheduled events.

10. A machine-readable storage medium storing a computer program providing a method for scheduling events according to network information, comprising:
acquiring network information, event information, and user preference information, wherein the network information is time-related;
matching the network information, the event information, and the user preference information to obtain a matching result; and
scheduling at least one event according to the matching result, wherein each event comprises event name, event time, and event location.

11. The machine-readable storage medium as claimed in claim 10, wherein the time-related network information comprises explicit time information and implicit time information.

12. The machine-readable storage medium as claimed in claim 10, wherein the time-related network information is retrieved based on a knowledge domain of a network.

13. The machine-readable storage medium as claimed in claim 12, wherein the time-related network information is retrieved by a network information search engine.

14. The machine-readable storage medium as claimed in claim 12, further analyzing information of the knowledge domain to acquire the time-related network information.

15. The machine-readable storage medium as claimed in claim 10, wherein the user reference information is recorded in a tree structure.

16. The machine-readable storage medium as claimed in claim 10 wherein the user reference information is acquired by a user interface.

17. The machine-readable storage medium as claimed in claim 10, wherein the scheduled events are recorded in a personal schedule.

18. The machine-readable storage medium as claimed in claim 10, further sending a notification according to the scheduled events.

19. A system for scheduling events according to network information, comprising:
an information acquisition module, acquiring network information, event information, and user preference information, wherein the network information is time-related;
an information matching module, coupled to the information acquisition module, matching the network information, the event information, and the user preference information to obtain a matching result; and
an event scheduling module, coupled to the information matching module, scheduling at least one event according to the matching result, wherein each event comprises event name, event time, and event location.

20. The system for scheduling events according to network information as claimed in claim 19, wherein the time-related network information comprises explicit time information and implicit time information.

21. The system for scheduling events according to network information as claimed in claim 19, wherein the time-related network information is retrieved based on a knowledge domain of a network.

22. The system for scheduling events according to network information as claimed in claim 21, further comprising a network information search engine to retrieve the time-related network information.

23. The system for scheduling events according to network information as claimed in claim 21, further comprising an information analysis module to analyze information of the knowledge domain to acquire the time-related network information.

24. The system for scheduling events according to network information as claimed in claim 19, wherein the user reference information is recorded in a tree structure.

25. The system for scheduling events according to network information as claimed in claim 19, wherein the user reference information is acquired by a user interface.

26. The system for scheduling events according to network information as claimed in claim 19, wherein the scheduled events are recorded in a personal schedule.

27. The system for scheduling events according to network information as claimed in claim 19, further comprising a notification module sending a notification according to the scheduled events.
